(19) United States
(12) Patent Application Publication
(10) Pub. No.: US 2020/0408298 A1
(43) Pub. Date: Dec. 31, 2020

(54) Compression Brake Control Shifter

(71) Applicant: Maurice Toussaint, Dupont, WA (US)

(72) Inventor: Maurice Toussaint, Dupont, WA (US)

(21) Appl. No.: 16/451,229

(22) Filed: Jun. 25, 2019

(51) Int. Cl. F16H 59/02; B60T 7/08; F16H 59/04

(52) U.S. Cl. CPC F16H 59/0217; B60T 7/085; F16H 59/0278; H01H 3/12; F16H 59/04; F16H 2059/0286; F16H 59/044

(57) ABSTRACT

A compression brake control shifter for convenient and safe compression brake control from the shifter includes a shifter body. The shifter body is configured to connect to a shift lever of a truck to manipulate a gear system of the truck. The truck has a gear splitter and a compression brake. A wiring harness is coupled to the shifter body and extends through the bottom side to be in operational communication with a CPU of the truck. A compression button, a hi/low gears switch, and a gear splitter switch are coupled to the shifter body and are in operational communication with the wiring harness to activate and alternatively deactivate the compression brake of the truck, to switch to and from a hi gear mode and a low gear mode of the gear system, and to activate and alternatively deactivate the gear splitter of the truck, respectively.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to compression brake controls and more particularly pertains to a new compression brake control for convenient and safe compression brake control from the shifter.

### BRIEF SUMMARY OF THE INVENTION

An embodiment of the disclosure meets the needs presented above by generally comprising a shifter body having a front side, a back side, a left side, a right side, a top side, and a bottom side. The shifter body is configured to connect to a shift lever of a truck to manipulate a gear system of the truck. The truck has a gear splitter and a compression brake operated by a CPU and powered by a power supply. A wiring harness is coupled to the shifter body and extends through the bottom side. The wiring harness is configured to be in operational communication with the CPU of the truck. A compression button is coupled to the shifter body and is in operational communication with the wiring harness to activate and alternatively deactivate the compression brake of the truck. A hi/low gears switch is coupled to the shifter body and is in operational communication with the wiring harness to switch to and from a hi gear mode and a low gear mode of the gear system. A gear splitter switch is coupled to the shifter body and is in operational communication with the wiring harness to activate and alternatively deactivate the gear splitter of the truck.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a compression brake control shifter according to an embodiment of the disclosure.

FIG. 2 is a side elevation view of an embodiment of the disclosure.

FIG. 3 is a side elevation view of an embodiment of the disclosure.

FIG. 4 is a block diagram of an embodiment of the disclosure.

### DETAILED DESCRIPTION OF THE INVENTION

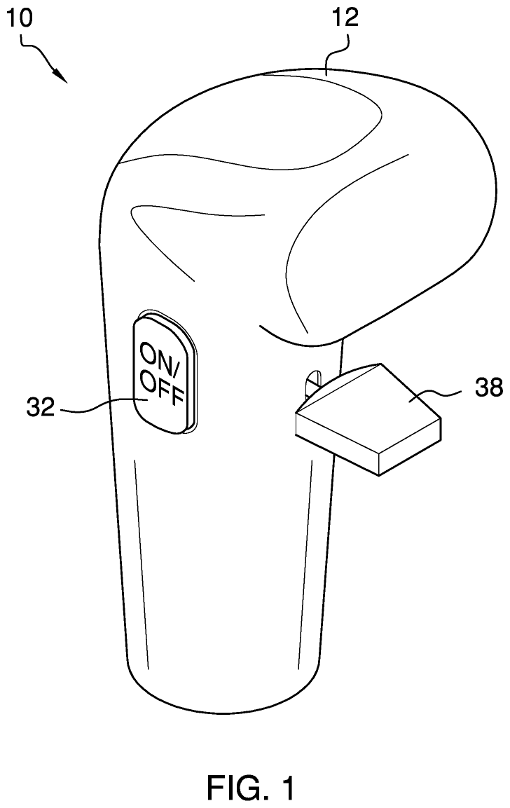

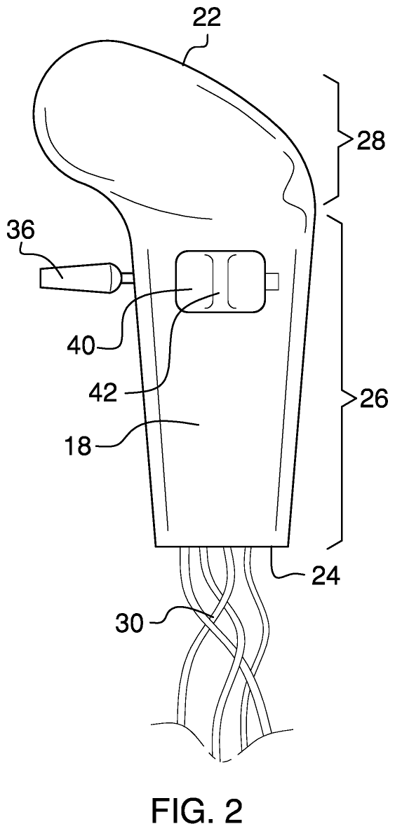

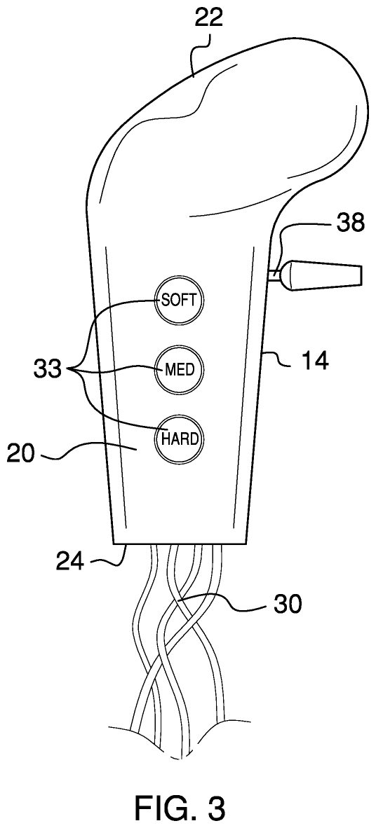

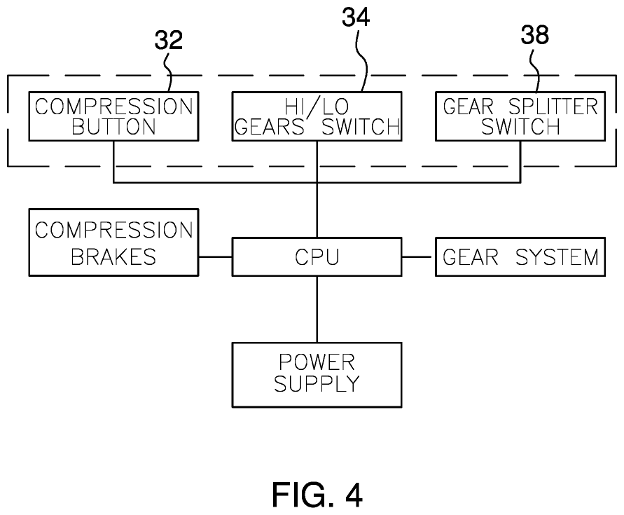

With reference now to the drawings, and in particular to FIGS. 1 through 4 thereof, a new compression brake control embodying the principles and concepts of an embodiment of the disclosure and generally designated by the reference numeral 10 will be described.

As best illustrated in FIGS. 1 through 4, the compression brake control shifter 10 generally comprises a shifter body 12 having a front side 14, a back side 16, a left side 18, a right side 20, a top side 22, and a bottom side 24. The shifter body 12 has a shaft portion 26 and a knob portion 28. The knob portion 28 extends from the top side 22 past the front side 14 to create an ergonomic shape. The shaft portion 26 tapers from the knob portion 28 to the bottom side 24. The shifter body 12 is configured to connect to a shift lever of a truck to manipulate a gear system of the truck. The truck has a gear splitter and a compression brake operated by a CPU and powered by a power supply. A wiring harness 30 is coupled to the shifter body 12 and extends through the bottom side 24. The wiring harness is configured to be in operational communication with the CPU of the truck. A compression button 32 is coupled to the right side 20 and is in operational communication with the wiring harness 30 to activate and alternatively deactivate the compression brake of the truck. The compression button 32 may comprise a set of three level setting buttons 33 to apply soft, medium, and hard compression, respectively. The set of three level setting buttons 33 may each be round and arranged in a vertical row. A hi/low gears switch 34 is coupled to the front side 14 of the shifter and has a tapered lever 36. The hi/low gears switch 34 is in operational communication with the wiring harness 30 to switch to and from a hi gear mode and a low gear mode of the gear system. A gear splitter switch 38 is coupled to the left side 18. The gear splitter switch 38 may be a slider switch 40 having a raised center 42 to provide leverage to move the slider switch 40 forwards and backwards. The gear splitter switch 38 is in operational communication with the wiring harness 30 to activate and alternatively deactivate the gear splitter of the truck.

In use, the shifter body 12 is used like a traditional shifter while the configuration of the compression button 32, the hi/low gears switch 34, and the gear splitter switch 38 allow a user to manipulate the truck's compression brake, hi gear mode and low gear mode, and gear splitter without moving her hand. The location of the compression button 32 can then become standardized to easily and ergonomically use the compression brake promoting safety, convenience, and peace of mind while minimizing use of the foot brake to minimize wear and tear.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A compression brake control shifter comprising:
a shifter body having a front side, a back side, a left side, a right side, a top side, and a bottom side, wherein the shifter body is configured to connect to a shift lever of a truck to manipulate a gear system of the truck, the truck having a gear splitter and a compression brake operated by a CPU and powered by a power supply;
a wiring harness coupled to the shifter body, the wiring harness extending through the bottom side, the wiring harness being configured to be in operational communication with the CPU of the truck;
a compression button coupled to the shifter body, the compression button being in operational communication with the wiring harness to activate and alternatively deactivate the compression brake of the truck;
a hi/low gears switch coupled to the shifter body, the hi/low gears switch being in operational communication with the wiring harness to switch to and from a hi gear mode and a low gear mode of the gear system; and
a gear splitter switch coupled to the shifter body, the gear splitter switch being in operational communication with the wiring harness to activate and alternatively deactivate the gear splitter of the truck.

2. The compression brake control shifter of claim 1 further comprising the shifter body having a shaft portion and a knob portion, the knob portion extending from the top side past the front side, the shaft portion tapering from the knob portion to the bottom side.

3. The compression brake control shifter of claim 2 further comprising the hi/low gears switch being coupled to the front side of the shifter.

4. The compression brake control shifter of claim 3 further comprising the hi/low gears switch having a tapered lever.

5. The compression brake control shifter of claim 1 further comprising the compression button being coupled to the right side.

6. The compression brake control shifter of claim 1 further comprising the gear splitter switch being coupled to the left side.

7. The compression brake control shifter of claim 6 further comprising the gear splitter switch being a slider switch.

8. The compression brake control shifter of claim 1 further comprising the slider switch having a raised center to provide leverage to move the slider switch forwards and backwards.

9. The compression brake control shifter of claim 1 further comprising the compression button comprising a set of three level setting buttons to apply soft, medium, and hard compression, respectively.

10. The compression brake control shifter of claim 1 further comprising the set of three level setting buttons each being round and arranged in a vertical row.

11. A compression brake control shifter comprising:
a shifter body having a front side, a back side, a left side, a right side, a top side, and a bottom side, the shifter body having a shaft portion and a knob portion, the knob portion extending from the top side past the front side, the shaft portion tapering from the knob portion to the bottom side, wherein the shifter body is configured to connect to a shift lever of a truck to manipulate a gear system of the truck, the truck having a gear splitter and a compression brake operated by a CPU and powered by a power supply;
a wiring harness coupled to the shifter body, the wiring harness extending through the bottom side, the wiring harness being configured to be in operational communication with the CPU of the truck;
a compression button coupled to the shifter body, the compression button being coupled to the right side, the compression button being in operational communication with the wiring harness to activate and alternatively deactivate the compression brake of the truck, the compression button comprising a set of three level setting buttons to apply soft, medium, and hard compression, respectively, the set of three level setting buttons each being round and arranged in a vertical row;
a hi/low gears switch coupled to the shifter body, the hi/low gears switch being coupled to the front side of the shifter and having a tapered lever, the hi/low gears switch being in operational communication with the wiring harness to switch to and from a hi gear mode and a low gear mode of the gear system; and
a gear splitter switch coupled to the shifter body, the gear splitter switch being coupled to the left side and being a slider switch, the slider switch having a raised center to provide leverage to move the slider switch forwards and backwards, the gear splitter switch being in operational communication with the wiring harness to activate and alternatively deactivate the gear splitter of the truck.
